(19) United States
(12) Patent Application Publication
(10) Pub. No.: US 2019/0356257 A1
(43) Pub. Date: Nov. 21, 2019

(54) METHOD AND APPARATUS FOR CONTROLLING A SWITCHED RELUCTANCE ELECTRIC MOTOR

(71) Applicant: GM Global Technology Operations LLC, Detroit, MI (US)

(72) Inventors: Suresh Gopalakrishnan, Troy, MI (US); Avoki M. Omekanda, Rochester, MI (US); Thomas W. Nehl, Shelby Township, MI (US); Chandra S. Namuduri, Troy, MI (US); Lei Hao, Troy, MI (US)

(73) Assignee: GM Global Technology Operations LLC, Detroit, MI (US)

(21) Appl. No.: 15/981,458

(22) Filed: May 16, 2018

(51) Int. Cl. H02P 25/086; F02N 11/08; H02P 23/30; H02P 25/092; H02P 25/098

(52) U.S. Cl. CPC H02P 25/086; F02N 11/0859; H02P 25/098; H02P 23/30; H02P 25/092; F02N 11/087

(57) ABSTRACT

A multi-phase switched reluctance motor including a rotor and a stator, an electronic commutator subassembly, and a controller. The electronic commutator subassembly includes an electronic motor control unit, a power inverter, and a rotational position sensor, with the power inverter being electrically connected to the stator of the switched reluctance motor. The controller is in communication with the electronic motor control unit, the power inverter, and the rotational position sensor. The controller includes an instruction set that is executable to characterize operation of the switched reluctance motor, dynamically determine inductance of the switched reluctance motor based upon the characterized operation, and execute a closed-loop torque control routine to control the switched reluctance motor based upon the dynamically determined inductance of the switched reluctance motor. The closed-loop torque control routine dynamically determines torque output from the switched reluctance motor based upon the dynamically determined inductance.

### INTRODUCTION

Switched reluctance electric motors may be employed in electric starters that are assembled onto internal combustion engines.

### SUMMARY

An electric motor is described, and includes a multi-phase switched reluctance motor including a rotor and a stator, an electronic commutator subassembly, and a controller. The electronic commutator subassembly includes an electronic motor control unit, a power inverter, and a rotational position sensor, with the power inverter being electrically connected to the stator of the switched reluctance motor. The controller is in communication with the electronic motor control unit, the power inverter, and the rotational position sensor. The controller includes an instruction set that is executable to characterize operation of the switched reluctance motor, dynamically determine inductance of the switched reluctance motor based upon the characterized operation, and execute a closed-loop torque control routine to control the switched reluctance motor based upon the dynamically determined inductance of the switched reluctance motor. The closed-loop torque control routine dynamically determines torque output from the switched reluctance motor based upon the dynamically determined inductance.

An aspect of the disclosure includes the instruction set being executable to dynamically monitor rotational position of the rotor and current and voltage supplied to the switched reluctance motor, and dynamically determine inductance of the switched reluctance motor based upon the characterized operation, the rotational position of the rotor, the current and the voltage supplied to the switched reluctance motor.

An aspect of the disclosure includes the instruction set being executable to dynamically determine a torque output from the switched reluctance motor based upon the inductance of the switched reluctance motor and determine a torque command for the switched reluctance motor, wherein the closed-loop torque control routine is executable to control the switched reluctance motor based upon the dynamically determined torque output from the switched reluctance motor and the torque command.

An aspect of the disclosure includes the instruction set being executable to characterize operation of the switched reluctance motor, including aligning one of the rotor poles with a corresponding one of the stator poles associated with one of the electrical phases of the switched reluctance motor and applying a predetermined voltage pulse to the one of the electrical phases having the rotor pole aligned with the stator pole associated with the one of the electrical phases, and simultaneously monitor electrical current in the associated electrical phase. A relationship between inductance at the aligned rotor pole and the monitored electrical current is determined based thereon.

An aspect of the disclosure includes applying a predetermined voltage pulse to one of the electrical phases having a rotor pole unaligned with the stator pole for the one of the electrical phases and simultaneously monitor electrical current in the associated electrical phase, and determining a relationship between inductance at the unaligned rotor pole and the monitored electrical current based thereon.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

One or more embodiments will now be described, by way of example, with reference to the accompanying drawings, in which:

FIG. 1 is a cutaway side-view of an embodiment of a starter, in accordance with the disclosure;

FIG. 2 is an exploded isometric view of a motor subassembly for a switched reluctance electric motor that may be disposed in the starter, in accordance with the disclosure;

FIG. 3-1 is a cutaway side-view of the switched reluctance electric motor, in accordance with the disclosure;

FIG. 3-2 is a cutaway end-view of the switched reluctance electric motor, in accordance with the disclosure;

FIG. 3-3 is a cutaway side-view of a rotor for the switched reluctance electric motor, in accordance with the disclosure;

FIG. 3-4 is a cutaway side-view of a stator for the switched reluctance electric motor, in accordance with the disclosure;

FIG. 4 is a schematic view of an electronic commutator subassembly for controlling the switched reluctance electric motor, in accordance with the disclosure;

FIG. 5-1 graphically shows a first perspective of inductance in relation to electrical current that is associated with operation of an embodiment of the switched reluctance motor, in accordance with the disclosure;

FIG. 5-2 graphically shows a second perspective of inductance in relation to electrical current that is associated with operation of an embodiment of the switched reluctance motor that is described herein, in accordance with the disclosure;

FIG. 6 schematically shows a motor characterization routine that includes calibration methodology to effect real-time self-learning of an embodiment of the switched reluctance motor, in accordance with the disclosure;

FIGS. 7-1 and 7-2 schematically illustrate a motor control scheme and associated flowchart that are related to dynamically control operation of an embodiment of the switched reluctance motor to transfer torque to a device employing a power inverter and controller, in accordance with the disclosure;

FIGS. 8-1 and 8-2 graphically show a current command and corresponding motor torque output, respectively, for a single phase of operation of an embodiment of the switched reluctance motor, wherein the current command is a PWM signal that varies between a set maximum point and zero torque, in accordance with the disclosure; and

FIGS. 9-1 and 9-2 graphically shows a current command and corresponding motor torque output, respectively, for a single phase of operation of an embodiment of the switched reluctance motor, wherein the current command is determined employing the motor control scheme described with reference to FIGS. 7-1 and 7-2, in accordance with the disclosure.

It should be understood that the appended drawings are not necessarily to scale, and present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some of these details. Moreover, for the purpose of clarity, certain technical material that is understood in the related art has not been described in detail in order to avoid unnecessarily obscuring the disclosure. Furthermore, the drawings are in simplified form and are not to precise scale. Furthermore, the disclosure, as illustrated and described herein, may be practiced in the absence of an element that is not specifically disclosed herein.

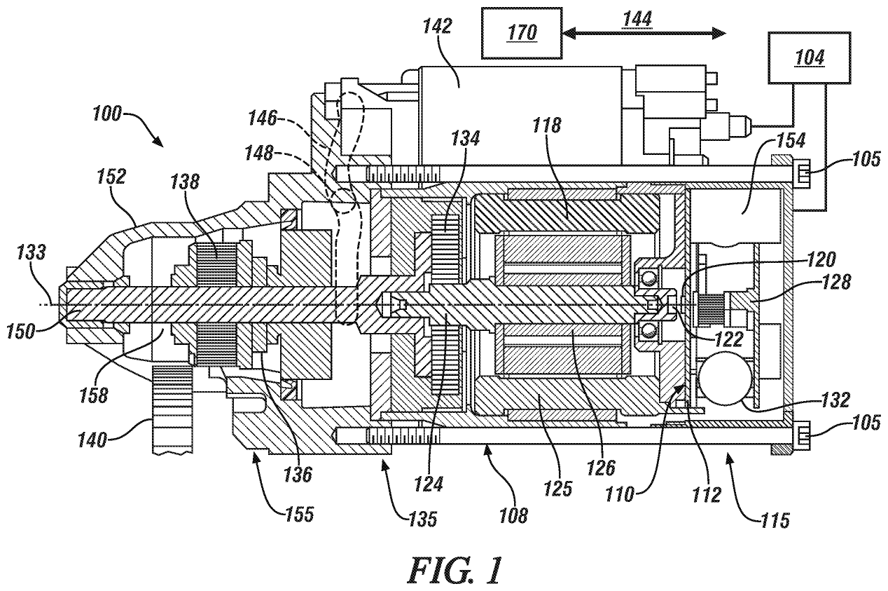

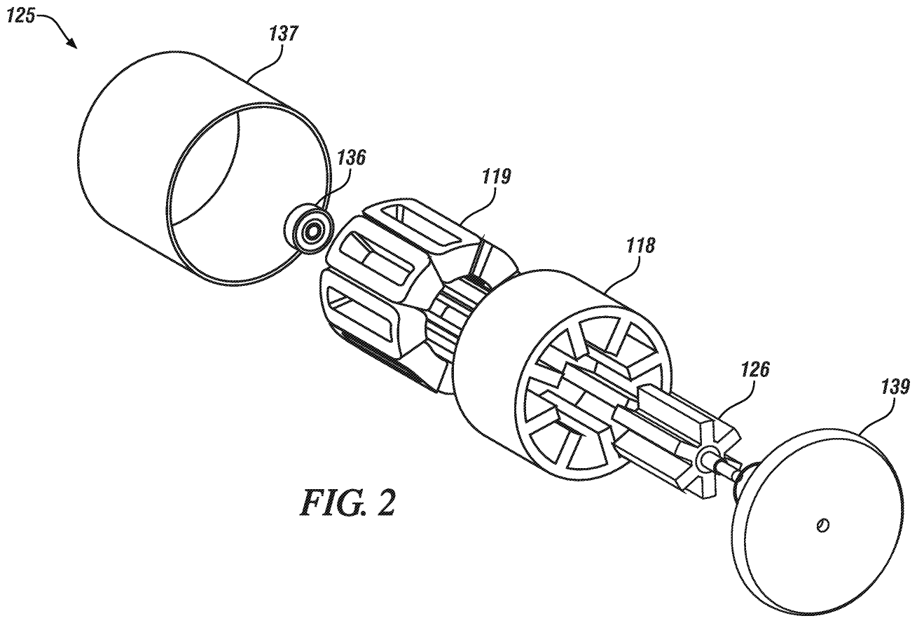

Referring to the drawings, wherein like reference numerals correspond to like or similar components throughout the several Figures, FIGS. 1 and 2, consistent with embodiments disclosed herein, illustrate a starter 100 that may be disposed on an internal combustion engine (engine) to provide engine cranking torque as part of an engine starting routine, including being employed in an engine stop-start routine. The engine may be disposed on a vehicle in one embodiment, and the vehicle may include, but not be limited to a mobile platform in the form of a commercial vehicle, industrial vehicle, agricultural vehicle, passenger vehicle, aircraft, watercraft, train, all-terrain vehicle, personal movement apparatus, robot and the like to accomplish the purposes of this disclosure. Alternatively, the starter 100 may be disposed on an engine that is employed on a stationary power source.

The starter 100 may be electrically connected, either via a cable or a power bus, to a DC power source 104 and may be in communication with a starter switch directly and/or via a controller 170. The starter 100 includes a switched reluctance electric machine (switched reluctance motor) 125, which is provided to generate engine cranking torque in response to a command to spin the engine.

The starter 100 is advantageously configured as a plurality of subassemblies including a gearbox/mounting subassembly 155 including a single solenoid-actuated pinion drive and planetary gear assembly, a motor subassembly 135 including the switched reluctance motor 125, and an electronic commutator subassembly 115. The gearbox/mounting subassembly 155, the motor subassembly 135, and the electronic commutator subassembly 115 are assembled into a unitary device employing one or a plurality of fasteners 105. This configuration facilitates assembly and testing, and provides high density packaging of power electronic elements, noise filters, controller, and interconnects to reduce EMI. The DC power source 104 is electrically connected to the switched reluctance motor 125 to provide DC current. The DC power source 104 may be a 12V DC voltage level, a 48V DC voltage level, or another DC voltage level.

The gearbox/mounting subassembly 155 includes a housing 152, shaft extension 150, planetary gear set 134, pinion gear 138, one-way clutch 136, pinion control solenoid 142 and a pinion lever control arm 146. The pinion lever control arm 146 is disposed between the pinion control solenoid 142 and the pinion gear 138, and is pivotably secured to the housing 152 via a pivot point 148. The planetary gear set 134 is coupled to a motor output shaft 124 of the switched reluctance motor 125.

Torque output that is generated by the switched reluctance motor 125 is transferred through the motor output shaft 124 to the planetary gear set 134, which provides a gear reduction mechanism to amplify the torque at a reduced speed to crank the engine. In some examples the reduction ratio may range 25:1 and 55:1. Torque transferred by the planetary gear set 134 is passed through the one-way clutch 136. The one-way clutch 136 is configured to lockup and pass torque in a first direction associated with engine cranking, and allow rotational slip in a second, opposite direction, as may happen in an overspeed condition that may be caused by firing of one or more engine cylinders during the starting event. In this way, negative torque is not returned to the switched reluctance motor 125. Additionally, engine overrun conditions may be absorbed at the one-way clutch 136 to compensate for speed undulations and allow engine speed to exceed starter motor speed.

The output torque generated by the switched reluctance motor 125 is transferred to a rotatable engine cranking input element 140 through a pinion gear 138. In one embodiment, the engine cranking input element 140 is a crankshaft of the engine. In one embodiment, the engine cranking input element 140 is a flywheel, belt drive, or chain drive which is coupled to the crankshaft of the engine. The pinion gear 138 is further arranged to translate and index between a first disengaged position and a second engaged position. The pinion control solenoid 142 includes an electrically activated piston having two positions, i.e., extended and retracted positions. The controller 170 may communicate a pinion control signal 144 to energize and de-energize the solenoid 142. In some examples, the pinion control signal 144 is coordinated with the motor operation signals. In alternate examples, the pinion control signal 144 may be provided by another propulsion system controller external to the starter motor subassembly 108. A pinion lever control arm 146 is disposed between the pinion control solenoid 142 and the pinion gear 138. When the pinion control solenoid 142 is de-energized, the piston is in the retracted position and the pinion gear 138 is retracted and disengaged. When the pinion control solenoid 142 is energized, the piston is moved to the extended position and the pinion gear 138 is extended and engaged. Energizing the pinion control solenoid 142 actuates a first end of the lever control arm 146, which pivots about pivot point 148, and an opposite end of the lever control arm 146 moves the pinion gear 138 to the second engaged position. In one example the pinion gear 138 is arranged to slide along the shaft extension 150 to index between the first disengaged position and the second engaged position. The housing 152 includes an opening 158 that allows the pinion gear 138 to engage the engine cranking input portion 140 to provide cranking torque.

The electronic commutator subassembly 115 includes an electronic motor control unit (MCU) 128, a power inverter 110, and one or a plurality of rotational position sensor(s) 120 that are integrated as a single unit that can be assembled onto the motor subassembly 135. The electronic commutator subassembly 115 is depicted as being coaxial relative to a center axis of rotation 133. Alternatively, one or more portions of the electronic commutator subassembly 115 may be arranged to be off-axis relative to the center axis of rotation 133 of the switched reluctance motor 125. In other alternative embodiments, the electronic commutator subassembly 115 is configured to be arranged as a standalone controller that is physically separated from the motor subassembly 135. Alternatively, the elements of the electronic commutator subassembly 115 may be integrated into the controller 170, which may be an engine control unit (ECU) controller. The electronic commutator subassembly 115 includes a power management portion including the power inverter 110 to convert direct current into three-phase current to drive the switched reluctance motor 125. The power inverter 110 may be integrated as part of a printed circuit board (PCB) 112 that is provided to manage a power portion of the electronic commutator subassembly 115.

The PCB 112 is connected to the stator windings 119 of the switched reluctance motor 125 to pass pulsewidth-modulated three-phase current through electrical terminals. The switched reluctance motor 125 may also include one or more position sensors 120 to detect the rotation and position of the rotor 126. In some examples, the position sensor(s) 120 is a Hall effect sensor disposed on the PCB 112 and arranged to pick up the presence of a position target that can be in the form of one or more position magnets 122 disposed on a portion of the motor output shaft 124 of the rotor 126. The position magnet 122 may be located concentric to the axis of rotation 133 of the motor output shaft 124. The magnetic field of the position magnet 122 rotates along with the rotor 126 (and output shaft 124) thus changing polarity direction and thereby providing input to the position sensor(s) 120 to indicate a change in rotational position of the rotor 126. The position sensor(s) 120 is arranged at a predetermined axial spacing from the magnet based on the type of magnet and the strength of the magnetic field. In one embodiment and as shown, the position magnet 122 may be arranged as a diametrically magnetized magnet that is disposed on an end of the motor output shaft 124, and the position sensor(s) 120 is disposed in an on-axis arrangement on the PCB 112. Alternatively, the position magnet 122 may be arranged as a radially magnetized magnet (not shown) that is disposed on an end of the motor output shaft 124 and the position sensor 120 is arranged in an off-axis arrangement at a predetermined radial spacing from the magnet that is disposed on the PCB 112.

Embodiments of the position sensor(s) 120 include raw angular position sensors that monitor a target to provide an incremental or absolute position signal. A position signal from an absolute position sensor is proportional to a true position regardless of whether the motor output shaft 124 is stationary or moving. An incremental position sensor detects positional changes. In one embodiment, the position sensor(s) 120 includes the multiplying encoder or digital Hall sensors, e.g., using polymer-bonded, multi-pole magnets, and in which encoder/Hall pulses and commutation pulses are generated as signal outputs. The position sensor 120 may also include an intelligent microprocessor-based chip to extract and transmit the position signals. Another embodiment of a position sensor is an analog Hall effect sensor, e.g., one using targets formed from neodymium magnets, or other field-based sensors operable for generating sine and cosine signals as sensor outputs. Other position sensor types generating similar sine and cosine outputs include inductive-type and reluctance-type position sensors. In one embodiment the position sensor 120 is a Hall effect sensor assembly that includes first and second Hall effect sensing elements that may be assembled onto an endcap of the switched reluctance motor and disposed in proximity to a rotor magnet assembly that may be an annular device that is disposed on and coupled to one end of the rotor 126.

The electronic commutator subassembly 115 also includes at least one processor such as motor control unit (MCU) 128, which includes gate drivers to accept low-power motor control signals from an external controller to activate the switched reluctance motor 125. The MCU 128 also regulates high-current drive inputs from the power source 104 to operate the power inverter 110. The MCU 128 is in communication with the power source 104 and may receive signals indicative of performance of the power source, such as battery state of charge, voltage feedback, current feedback or other parameters. The MCU 128 may transmit signals indicating the timing of an engine restart to be used as an input to other functions of a vehicle propulsion system such as transmission shift scheduling, hybrid vehicle propulsion mode selection, and power regeneration for example.

In some examples the MCU 128 is a processor disposed on a control board 132 that is spaced from the power management portion. The MCU 128 may include a digital signal processor (DSP) microcontroller or an application-specific integrated circuit (ASIC) for example. The spacing between the control portion and the power portion is arranged to assist with thermal management of the control board 132 by allowing heat generated from the power management portion to sufficiently dissipate without affecting the operation of the MCU 128. Also, the spacing reduces interference at the MCU 128 related to electrical noise that may be generated by the switches of the power inverter 110. Signals indicative of the starter system operation are transmitted to the control board 132. Commands are sent from the MCU 128 to switches of the power inverter 110. Operation of the inverter switches may be based on a combination of rotor position, temperature, motor feedback current, battery feedback current, battery voltage, ECU signals, or other parameters. The power management portion may also include one or more capacitors 154 which operate as filters to smooth the PWM current output from the switches. In some alternate examples, power filtering portions of the electronics may be located external to the housing of the electronic commutator subassembly 115.

FIG. 2 depicts an exploded isometric view of the motor subassembly 135 to illustrate details associated therewith, including the switched reluctance motor 125 having an annular-shaped stator 118 and rotor 126 mounted on the motor output shaft 124 that defines an axis of rotation 133, a plurality of stator windings 119, and a bearing that are encased within a housing 137 and an accompanying end cap 139. The switched reluctance motor 125 lacks a commutator, permanent magnets, a rotor squirrel cage or other rotor windings. The rotor 126 is formed by a plurality of stacked laminates formed from ferromagnetic material and including a plurality of outwardly projecting rotor poles 127. The stator 118 is formed by a plurality of stacked laminates formed from ferromagnetic material and including a plurality of inwardly projecting stator poles 117, with void regions 116 formed between adjacent stator poles 117. The stator windings 119 are inserted into the void regions 116. The MCU 128 sends commands to the switches of the power inverter 110, which sequentially energizes the stator windings 119 of the switched reluctance motor 125 to generate a rotating electromagnetic field to urge the rotor 126 to rotate. The switched reluctance motor 125 generates torque employing magnetic attraction that is induced on the stator poles 117 and the salient rotor poles 127 formed on the rotor 126, as described herein.

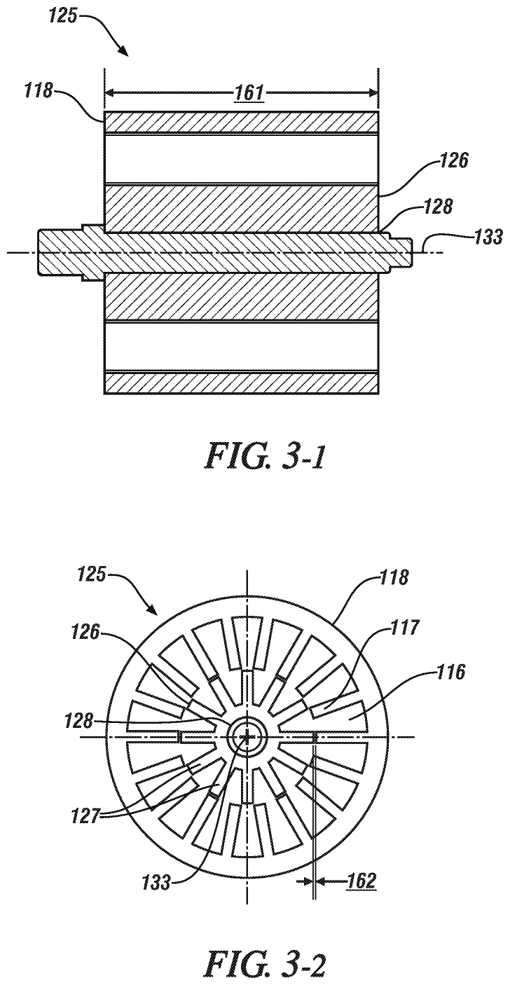

FIGS. 3-1 to 3-4 illustrate aspects of the switched reluctance motor 125 including the stator 118, rotor 126, rotor shaft 124 and axis of rotation 133, including a plurality of critical design dimensions. The stator 118 includes a plurality of radially-oriented inwardly-projecting stator poles 117 with intervening stator voids 116, into which stator coil windings 119 are inserted. The rotor 126 includes a plurality of radially-oriented outwardly-projecting rotor poles 127 that project from the rotor shaft 124. Critical dimensions may include as follows:
an active length 161, which is an axial length of the overlap between the stator 118 and the rotor 126;
an airgap length 162, which is a radial length of an airgap between the inwardly-projecting stator poles 117 and the outwardly-projecting rotor poles 127;
an outside diameter 167 of the stator 118;
a rotor pole length 164, which is a radial length of each of the rotor poles 127 projecting from the rotor shaft 124;
a stator pole length 165, which is a radial length of each of the stator poles 117 projecting from an inner surface of the stator 118;
a stator pole arc 166, A_{S}, which is an angle measured between two radial lines projecting from the axis of rotation 133, wherein the two radial lines intersect with respective opposite corner points of one of the inwardly-projecting stator poles 117; and
a rotor pole arc 163, A_{R}, which is an angle measured between two radial lines projecting from the axis of rotation 133, wherein the two radial lines intersect with respective opposite corner points of one of the outwardly-projecting rotor poles 127.

The switched reluctance motor 125 is configured as a three-phase device having a first quantity N_{S} of the stator poles 117 and a second quantity N_{R} of the rotor poles 127, generating a number of angular steps. An angular step is defined as equal to the difference between the rotor pole pitch and the stator pole pitch. Following these geometric definitions, the relationship between the quantities of stator/rotor poles (N_{S}/N_{R}), for the three-phase switched reluctance motor 125 is determined in accordance to the relationship:

N_{R}=⅔N_{S}

N_{S}: number of stator poles and N_{R}: number of rotor poles;

For the three-phase switched reluctance motor 125, N_{S} is a multiple of 3 and N_{R} is an integer.

Advantageously, the switched reluctance motor 125 has a quantity of the stator poles 117 that is between 8 and 24, and a quantity of the rotor poles 127 that is between 6 and 16.

In one advantageous embodiment, there are a quantity of 18 stator poles 117 and a quantity of 12 rotor poles 127, referred to as an 18/12 combination.

In one advantageous embodiment, there are a quantity of 24 stator poles 117 and a quantity of 16 rotor poles 127, referred to as a 24/16 combination.

In one advantageous embodiment, the switched reluctance motor 125 is configured as follows:

a machine outer diameter 167 that is less than 85 mm;

an active length 161 that is less than 50 mm;

an airgap length 162 that is between 0.1-0.5 mm;

a ratio of the rotor pole arc 163 A_{R} and the stator pole arc 166 A_{S} that is greater than or equal to 1.0. Advantageously, the ratio A_{R}/A_{S} is between 1.0 and 1.2;

a ratio of the stator diameter 167 d_{S} and a rotor diameter 168 d_{R} that is at least 2.0:1. Advantageously, the ratio d_{S}/d_{R} is between 1.8 and 2.5; and

a ratio of the stator pole length 165 h_{S} and the rotor pole length 164 h_{R} that is equal or greater than 2.5. Advantageously, the ratio h_{S}/h_{R} is between 2.1 and 2.5.

The term “controller” and related terms such as control module, module, control, control unit, processor and similar terms refer to one or various combinations of Application Specific Integrated Circuit(s) (ASIC), electronic circuit(s), central processing unit(s), e.g., microprocessor(s) and associated non-transitory memory component(s) in the form of memory and storage devices (read only, programmable read only, random access, hard drive, etc.). The non-transitory memory component is capable of storing machine readable instructions in the form of one or more software or firmware programs or routines, combinational logic circuit(s), input/output circuit(s) and devices, signal conditioning and buffer circuitry and other components that can be accessed by one or more processors to provide a described functionality. Input/output circuit(s) and devices include analog/digital converters and related devices that monitor inputs from sensors, with such inputs monitored at a preset sampling frequency or in response to a triggering event. Software, firmware, programs, instructions, control routines, code, algorithms and similar terms mean controller-executable instruction sets including calibrations and look-up tables. Each controller executes control routine(s) to provide desired functions. Routines may be executed at regular intervals, for example each 100 microseconds during ongoing operation. Alternatively, routines may be executed in response to occurrence of a triggering event. Communication between controllers, and communication between controllers, actuators and/or sensors may be accomplished using a direct wired point-to-point link, a networked communication bus link, a wireless link or another suitable communication link. Communication includes exchanging data signals in suitable form, including, for example, electrical signals via a conductive medium, electromagnetic signals via air, optical signals via optical waveguides, and the like. The data signals may include discrete, analog or digitized analog signals representing inputs from sensors, actuator commands, and communication between controllers. The term “signal” refers to a physically discernible indicator that conveys information, and may be a suitable waveform (e.g., electrical, optical, magnetic, mechanical or electromagnetic), such as DC, AC, sinusoidal-wave, triangular-wave, square-wave, vibration, and the like, that is capable of traveling through a medium. The term ‘model’ refers to a processor-based or processor-executable code and associated calibration that simulates a physical existence of a device or a physical process. As used herein, the terms ‘dynamic’ and ‘dynamically’ describe steps or processes that are executed in real-time and are characterized by monitoring or otherwise determining states of parameters and regularly or periodically updating the states of the parameters during execution of a routine or between iterations of execution of the routine. The terms “calibration”, “calibrate”, and related terms refer to a result or a process that compares an actual or standard measurement associated with a device with a perceived or observed measurement or a commanded position. A calibration as described herein can be reduced to a storable parametric table, a plurality of executable equations or another suitable form. A parameter is defined as a measurable quantity that represents a physical property of a device or other element that is discernible using one or more sensors and/or a physical model. A parameter can have a discrete value, e.g., either “1” or “0”, or can be infinitely variable in value.

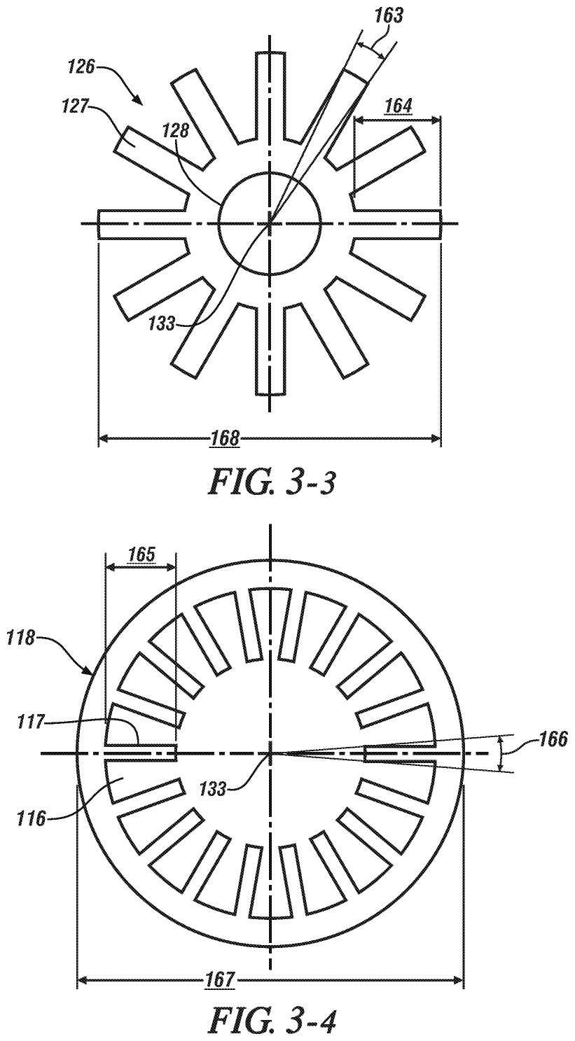

FIG. 4 schematically shows an embodiment of a circuit 400 for the power inverter 110, which is an element of the electronic commutator subassembly 115 for controlling operation of an embodiment of the switched reluctance motor 125 of the starter 100. The switched reluctance motor 125 is configured as a three-phase device in one embodiment. Other multi-phase electric motor configurations can be advantageously configured and operated employing the concepts described herein, and thus fall within the scope of this disclosure. The circuit 400 is configured to supply pulsewidth-modulated electric power originating from the DC power source 104 to the stator windings 119 of the switched reluctance motor 125, which are depicted as first, second and third stator windings 422, 432, 442, respectively. An example pulsewidth-modulated control scheme is indicated by a control graph, including Q1 corresponding to a control signal for the first stator winding 422, Q2 corresponding to a control signal for the second stator winding 432, and Q3 corresponding to a control signal for the third stator winding 442, all plotted against electrical degrees of rotation, which are indicated on the horizontal axis. Each of the first, second and third stator windings 422, 432, 442 is arranged in series with a corresponding first, second and third power switch 424, 434, 444, respectively, between a first high-voltage bus 412 and a low-voltage bus 414, which are electrically connected to the DC power source 104.

The first high-voltage bus 412 is electrically connected to the DC power source 104 via an intervening power control switch 415. Each junction of the first, second and third stator windings 422, 432, 442 and corresponding switch 424, 434, 444 is electrically connected to a second high-voltage bus 413 via a corresponding first, second and third diode 426, 436, 446, respectively. A fourth diode 456 provides a shunt/drain between the first high-voltage bus 412 and the low-voltage bus 414.

Activations and deactivations of the first, second and third power switches 424, 434, 444 and the power control switch 415 are controlled by gate drivers that are disposed in the MCU 128. The first, second and third power switches 424, 434, 444 are operably controlled to transmit electric power from the DC power source 104 to the corresponding windings of the stator 118 to drive the switched reluctance motor 125. In one embodiment, the first, second and third power switches 424, 434, 444 are MOSFET devices. Alternatively, the first, second and third power switches 424, 434, 444 can be formed using a single one of or a plurality of paralleled MOSFETs, GaN FETs, SiC FETs, IGBTs or other type of semiconductor switches. The PCB structure may be composed as an FR4 multi-layer board having suitable thickness copper interlayers. In other alternate examples, the power management portion may include a power module assembly instead of a PCB where microchips are directly mounted to a direct bonded copper (DBC) substrate. A sheet of copper or aluminum may be bonded to one or both sides of an insulated substrate (e.g. alumina or silicon nitride) with copper traces. The sheet can be pre-formed prior to firing or chemically etched using printed circuit board technology to form an electrical circuit, while a bottom sheet may be kept plain. In further examples, microchips may be connected to copper bus bars or on lead frames also having isolation conducive to electrical switching. Generally, a power management portion includes a plurality of switches configured to manage power from the power source and apply pulsewidth modulation (PWM) as discussed in more detail below. These switches can be packaged with leads ready for assembly on the PCB or may be formed “in die” and mounted on a copper lead frame and wire-bonded to make the electrical connections.

The circuit 400 for the power inverter 110 is configured as a modified (n+1) switch converter that is operable to control an embodiment of the switched reluctance motor 125 of the starter 100. Alternatively, the circuit 400 for controlling an embodiment of the switched reluctance motor 125 can be configured as an asymmetric half-bridge electrical converter, a bifilar winding electrical converter, a C-dump electrical converter, or another suitable electrical converter for transforming DC electric power to AC electric power that can be employed to control operation of an embodiment of the switched reluctance motor 125.

Operation of the starter 100 may be controlled by controller 170, which is in communication with the electronic commutator subassembly 115 that includes the MCU 128, power inverter 110, and rotational position sensor(s) 120. The controller 170 includes an instruction set, the instruction set that is executable to dynamically characterize operation of the switched reluctance motor 125, dynamically determine inductance of the switched reluctance motor 125 based upon its characterized operation and execute a closed-loop torque control routine to control the switched reluctance motor 125 based upon the dynamically determined inductance. The closed-loop torque control routine dynamically determines the torque output from the switched reluctance motor 125 based upon the dynamically determined inductance. This operation is described with reference to FIGS. 5-1, 5-2, 6, 7-1, and 7-2.

The switched reluctance motor 125 operates by sequentially applying electric power to the stator windings 119 employing pulsewidth-modulated multi-phase current that is supplied from the electronic commutator subassembly 115. The electric power applied to the stator windings 119 induces magnetic fields that urge the rotor poles 127 to mechanically align with the excited stator poles 117.

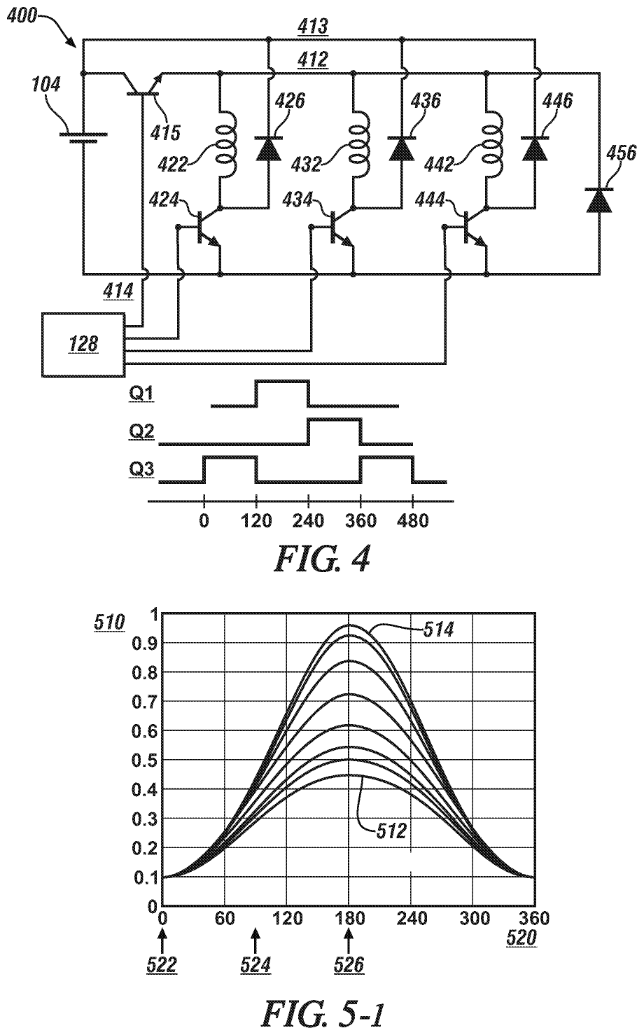

FIG. 5-1 graphically shows inductance in relation to electrical current that is associated with operation of an embodiment of the switched reluctance motor 125 that is described herein. The inductance magnitude is indicated on the vertical axis 510 in relation to rotor position, which is shown on the horizontal axis 520. The rotor position is shown over a range from 0 electrical degrees to 360 electrical degrees. The electrical current includes current values including a minimum current 514 and a maximum current 512, and a range of intermediate current values. For each of the current values between the minimum current 514 and the maximum current 512, a maximum inductance occurs when the rotor position is at 180 electrical degrees, referred to as an aligned inductance La(i) 526. For each of the current values between the minimum current 514 and the maximum current 512, a minimum inductance occurs when the rotor position is at 0 or 360 electrical degrees, referred to as an unaligned inductance Lu(i) 522. For each of the current values between the minimum current 514 and the maximum current 512, an midpoint inductance occurs between the rotor positions of 0 electrical degrees and 180 electrical degrees, referred to as a midpoint inductance Lm(i) 524.

FIG. 5-2 graphically shows inductance in relation to electrical current that is associated with operation of an embodiment of the switched reluctance motor 125 that is described herein, employing the data from FIG. 5-1. Here, the inductance magnitude is indicated on the vertical axis 510 in relation to current, which is shown on the horizontal axis 515 for a range between 0 current 511 and the maximum current 514, for the data graphically shown with reference to FIG. 5-1. The results indicate that the aligned inductance La(i) 526 is greater than the midpoint inductance Lm(i) 524 and the unaligned inductance Lu(i) 522, and decreases with an increase in the current to the maximum current 514, whereas the unaligned inductance Lu(i) 522 is minimally affected by the increase in the current to the maximum current 514.

The relationship between electrical current and inductance in the switched reluctance motor 125 can be characterized as follows:

L(θ,i)=L₀(i)+Σₓ₌₁ⁿ(Lₓ(i)*(cos(xNrθ+ϕx))) [1]

wherein

L₀(i)=f(Lₐ(i),Lₘ(i),Lᵤ(i)), and

Lₓ(i)=g(Lₐ(i),Lₘ(i),Lᵤ(i))

and wherein:
L(θ, i) represents inductance at a given electrical angle θ and current i;
La(i) is the aligned inductance;
Lm(i) is the midpoint inductance;
Lu(i) is the unaligned inductance;
Nr is the number or quantity of rotor poles; and
ϕx is a phase angle.

The inductance terms La(i), Lm(i) and Lu(i) may be represented as polynomial equations in relation to the current i, as follows:

La(i)=a₀₁+a₁₁(i)+a₂₁(i)²+a₃₁(i)³+ . . .

Lm(i)=a₀₂+a₁₂(i)+a₂₂(i)²+a₃₂(i)³+ . . .

Lu(i)=a₀₃+a₁₃(i)+a₂₃(i)²+a₃₃(i)³+ . . .

The relationship between electrical current and inductance in the switched reluctance motor 125 can be applied to dynamically characterize the operation of the switched reluctance motor 125. Each of the phases of the switched reluctance motor are independent, i.e., inductance in one of the phases has no effect on the inductance of the other phases.

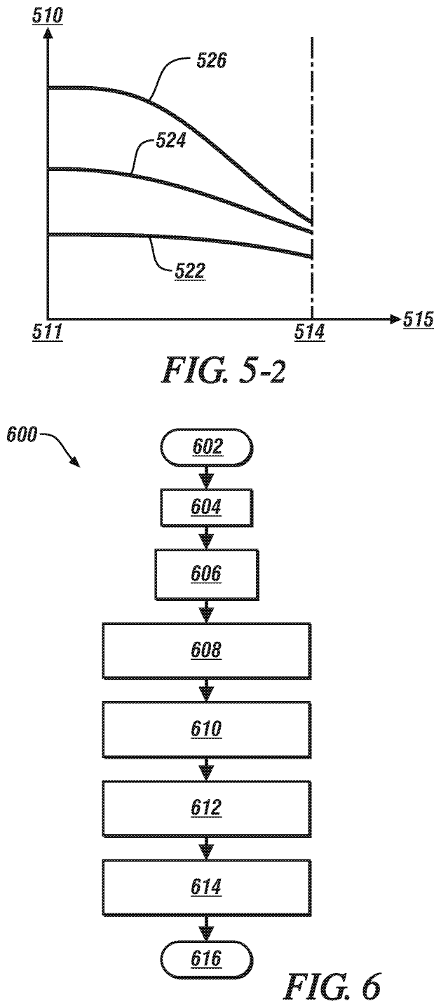

FIG. 6 schematically shows a motor characterization routine 600 that includes calibration methodology to effect real-time self-learning of an embodiment of the switched reluctance motor 125, employing an embodiment of the system described hereinabove. Table 1 is provided as a key wherein the numerically labeled blocks and the corresponding functions are set forth as follows, corresponding to the motor characterization routine 600. The teachings may be described herein in terms of functional and/or logical block components and/or various processing steps. The block components may be composed of hardware, software, and/or firmware components that have been configured to perform the specified functions.

TABLE 1

| BLOCK | BLOCK CONTENTS |
|---|---|
| 602 | Start |
| 604 | Align at phase A |
| 606 | Apply voltage pulse to phase A |
| 608 | Monitor and record current from 0 to Imax |
| 610 | Calculate polynomial coefficients for |
| | inductance at aligned position |
| 612 | Apply voltage pulse to phases B and C; |
| | Monitor and record current from 0 to Imax |
| 614 | Calculate polynomial coefficients for |
| | inductance at intermediate positions |
| 616 | End |

Execution of the motor characterization routine 600 may proceed as follows. The steps of the motor characterization routine 600 may be executed in a suitable order, and are not limited to the order described with reference to FIG. 6. As employed herein, the term “1” indicates an answer in the affirmative, or “YES”, and the term “0” indicates an answer in the negative, or “NO”.

The motor characterization routine 600 is executed to develop a calibration that can be employed to dynamically control an individual one of the switched reluctance motors 125. Upon completion of the motor characterization routine 600, motor inductance may be dynamically determined based upon the current i and the phase angle ϕx employing Eq 1. The motor characterization routine 600 is described with reference to a three-phase switched reluctance motor 125, including phases that are nominally referred to as A, B and C.

Upon initiation (602), the motor characterization routine 600 executes by determining complete alignment of the one of the rotor poles and corresponding one of the stator poles that is associated with phase A (604), at which time a primary voltage pulse is applied to phase A (606). The primary voltage pulse may be of a voltage magnitude equal to or greater than the system voltage for the starter 100, and of a duration of 1-2 ms. During the applying of the primary voltage pulse to phase A, the phase current flowing through phase A is monitored and recorded, up to achieving a maximum current, Imax (608). The monitored current flowing through phase A is employed using a curve-fitting routine to calculate polynomial coefficients for EQ. 1 for the inductance at the aligned position (610). A curve fitting routine may employ regression analysis to calculate the polynomial coefficients for EQ. 1, wherein the polynomial coefficients include a₀₁, a₀₂, a₀₃, . . . a₁₁, a₀₂, a₁₂, a₂₂, a₃₂, . . . a₀₃, a₁₃, a₂₃, a₃₃ . . . .

With the switched reluctance motor 125 still in the aligned position relative to phase A, secondary voltage pulses are sequentially applied to phases B and C, wherein each of the secondary voltage pulses is similar to the primary voltage pulse that is applied to phase A. Again, corresponding phase currents are monitored and recorded from 0 to the maximum current, Imax (612). The monitored current flowing through phases B and C are employed using a curve-fitting routine to calculate polynomial coefficients for EQ. 1 for the inductance at the intermediate positions (614). Upon completion of the curve fitting routine, the characterization is complete (616) and the resulting coefficients are captured and stored in the controller 170. The result of the motor characterization routine 600 can be employed in another routine to dynamically determine motor inductance based upon the current i and the phase angle ϕx employing Eq 1.

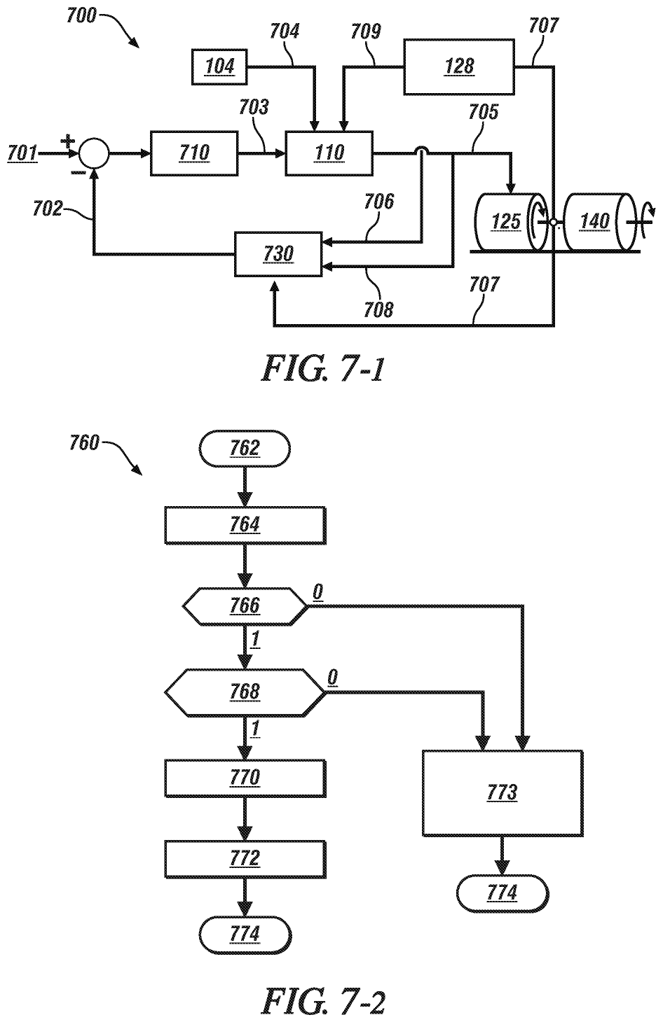

FIG. 7-1 schematically illustrates a motor control scheme 700 to dynamically control operation of an embodiment of the switched reluctance motor 125 to transfer torque to a device, e.g., to the engine flywheel 140, employing embodiments of the power inverter 110 and the MCU 128. Detailed operation of the control scheme 700 that includes operation to minimize torque ripple is described with reference to a torque ripple control routine 760 that is described with reference to FIG. 7-2. The control concepts described herein may be applied to various embodiments of the switched reluctance motor 125, and are not limited to the application of the switched reluctance motor 125 in the starter 100 to effect engine starting.

The control scheme 700 employs a torque estimator routine 730 that dynamically estimates a total motor torque 702 in real-time based upon monitored parameters that include electrical current 706, voltage 708 and rotor position 707 from the switched reluctance motor 125. The dynamic estimation may be calculated at a resolution of 1 electrical degree in one embodiment. Preferably, the electrical current 706 is measured for each of the motor phases.

The torque estimator routine 730 estimates torque for each of the phases in accordance with the following equation:

$${T}_{e , phase} = 0.5 * \frac{\partial {L}_{phase} ( θ , i )}{\partial θ} {i}_{phase}^{2} \qquad [ 2 ]$$

wherein:

T_{e,phase} is the estimated torque for the phase, i.e., one of phases A, B or C;

∂Lₚₕₐₛₑ (θ,i) represents the change in inductance for the phase, and is determined employing EQ. 1, above;

iₚₕₐₛₑ is the current for the phase; and

θ is the phase angle.

The estimated motor torque 702, Tₑ can be determined by arithmetically summing the estimated torque values for each of the phases, indicated by x, as determined employing EQ. 2, as follows:

Tₑ=Σₓ₌₁^{N}(Tₑ(x)) [3]

The motor control scheme 700 operates by determining an arithmetic difference between a motor torque command 701 and the estimated motor torque 702, which is input to a PI (proportional-integral) controller 710, which determines a current command 703 based thereon. The current command 703 is input to the power inverter 110, along with voltage 704 from the DC power source 104 and PWM control signals 709 that are generated by the MCU 128. The power inverter 110 transfers electric power 705 to the switched reluctance motor 125, which operates in response to spin the engine flywheel 140.

Operation of the motor control scheme 700, including selective operation to minimize torque ripple is described employing a torque ripple control routine 760 that is illustrated with reference to FIG. 7-2. Table 2 is provided as a key wherein the numerically labeled blocks and the corresponding functions are set forth as follows, corresponding to the torque ripple control routine 760. The teachings may be described herein in terms of functional and/or logical block components and/or various processing steps. The block components may be composed of hardware, software, and/or firmware components that have been configured to perform the specified functions.

TABLE 2

| BLOCK | BLOCK CONTENTS |
|---|---|
| 762 | Initiate routine |
| 764 | Monitor motor torque command |
| 766 | Is motor speed less than base speed? |
| 768 | Is torque ripple control mode activated? |
| 770 | Te, err = Tcmd − Te, estimated |
| 772 | Icmd = kp * Te, err + ki* intg(Te, err) dt |
| 773 | From Torque command, determine desired |
| | current reference from lookup table |
| 774 | End |

Operation of the torque ripple control routine 760 operates to minimize torque ripple, and proceeds as follows. The steps may be executed in a suitable order, and are not limited to the order described with reference to FIG. 7-2. As employed herein, the term “1” indicates an answer in the affirmative, or “YES”, and the term “0” indicates an answer in the negative, or “NO”.

The motor torque command is monitored, along with monitoring motor speed (764). When the motor speed is less than a base speed (766)(0), a desired motor current is selected from a pre-calibrated relationship between motor speed, motor torque, and operating characteristics of the switched reluctance motor 125 (773), and implemented to control operation thereof, and this iteration ends (774).

When the motor speed is greater than the base speed (766)(1), the routine determines if a torque ripple control mode has been activated (768), and if not (768)(0), the desired motor current is selected from the pre-calibrated relationship between motor speed, motor torque, and operating characteristics of the switched reluctance motor 125 (773), and implemented to control operation thereof, and this iteration ends (774). The torque ripple control mode is advantageously activated at low motor speeds, e.g., when the motor speed is less than 1000 rpm in one embodiment.

When the torque ripple control mode has been activated (768)(1), a torque error term is determined based upon a difference between the torque command and the estimated torque, as described with reference to EQS. 2 and 3 of FIG. 7-1 (770). The torque error term is subjected to proportional-integral control, i.e., PI controller 710 to determine the current command 703 (774), as shown with reference to FIG. 7.1. The current command 703 is input to the power inverter 110, along with voltage 704 from the DC power source 104 and PWM control signals 709 that are generated by the MCU 128. The power inverter 110 operates in response to the current command 703, voltage 704, and the PWM control signals 709 to transfer electric power 705 to control operation of the switched reluctance motor 125, and this iteration ends (774).

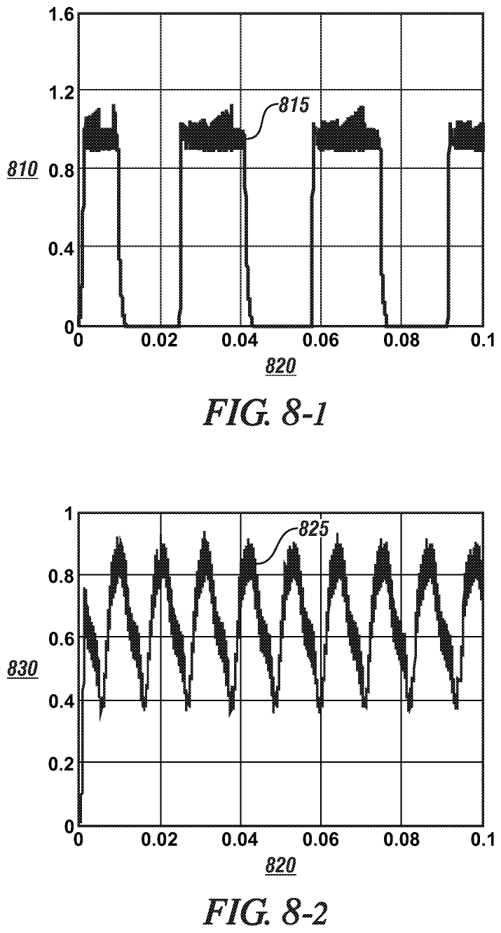

FIG. 8-1 graphically shows a current command 815 for a single phase of operation of an embodiment of the switched reluctance motor 125, wherein the current command 815 is a PWM signal that is shown as current on the vertical axis 810 plotted in relation to time on the horizontal axis 820. As seen, the magnitude of the current command 815 varies between a set maximum point and a minimum point. FIG. 8-2 graphically shows a corresponding torque output 825 associated with the operation of the embodiment of the switched reluctance motor 125, wherein torque is shown on the vertical axis 830 plotted in relation to time on the horizontal axis 820. The torque output 825 includes a substantial swing in magnitude during the activation portion, which may be manifested in audible noise and/or system vibration.

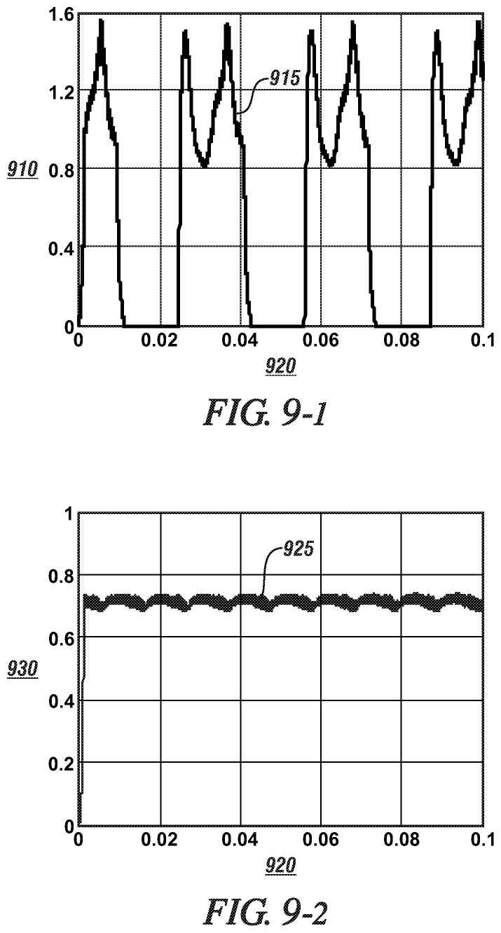

FIG. 9-1 graphically shows a current command 915 for a single phase of operation of an embodiment of the switched reluctance motor 125, wherein the current command 915 is determined employing the motor control scheme 700 described with reference to FIGS. 7-1 and 7-2, including the current command 915 on the vertical axis 910 plotted in relation to time on the horizontal axis 920. As seen, the magnitude of the current command 915 varies in response to the estimated torque and the PI control routine. FIG. 9-2 graphically shows a corresponding torque output 925 associated with the operation of the embodiment of the switched reluctance motor 125, wherein torque is shown on the vertical axis 930 plotted in relation to time on the horizontal axis 920. The torque output 925 has a de minimis variation during the activation portion. This effect upon the torque output 925 as shown results in little or no discernible torque variation, which results in minimal or no negative effect on NVH (noise-vibration-harshness) ratings during operation of the switched reluctance motor 125.

The concepts described herein provide a configuration with adaptive, self-learning controls for a switched reluctance motor suitable for an application such as an engine starter. Characterizing the switched reluctance motor in real-time is useful for controlling the motor over its entire operating speed/torque range, which facilitates dynamic torque control to minimize the torque ripple and thus improve NVH.

Features associated with the switched reluctance machine (SRM) 125 include robustness, simplicity of machine construction, a desirable fail-safe capability and quasi-insensitivity to motor temperature. Unlike other types of electric motors, SRM has no brushed commutator, no permanent magnets, no rotor winding, and no squirrel cage, which make it capable of high speed operation and fast response due to low inertia. The performance is independent of the environment temperature during the current-controlled mode of operation. The machine performance depends on the stator ohmic resistance in a single pulse mode of operation. This stator ohmic resistance is based upon the winding temperature. There are desired combinations of pole numbers and phases for the SRM to be self-starting, symmetrical, reversible, and low-cost for a fast starter application.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

What is claimed is:

1. A starter for an internal combustion engine, comprising:
a multi-phase switched reluctance motor including a rotor and a stator;
an electronic commutator subassembly including an electronic motor control unit, a power inverter, and a rotational position sensor, including the power inverter being electrically connected to the stator of the switched reluctance motor; and
a controller in communication with the electronic motor control unit, the power inverter, and the rotational position sensor, the controller including an instruction set, the instruction set executable to:
characterize operation of the switched reluctance motor,
dynamically determine inductance of the switched reluctance motor based upon the characterized operation, and
execute a closed-loop torque control routine to control the switched reluctance motor based upon the dynamically determined inductance of the switched reluctance motor;
wherein the closed-loop torque control routine dynamically determines torque output from the switched reluctance motor based upon the dynamically determined inductance.

2. The starter of claim 1, further comprising the instruction set being executable to:
dynamically monitor rotational position of the rotor and current and voltage supplied to the switched reluctance motor, and
dynamically determine the inductance of the switched reluctance motor based upon the characterized operation, the rotational position of the rotor, the current and the voltage supplied to the switched reluctance motor.

3. The starter of claim 1, further comprising the instruction set being executable to:
dynamically determine the torque output from the switched reluctance motor based upon the inductance of the switched reluctance motor,
determine a torque command for the switched reluctance motor, and
execute the closed-loop torque control routine to control the switched reluctance motor based upon the dynamically determined torque output from the switched reluctance motor and the torque command.

4. The starter of claim 1, wherein the rotor includes a first plurality of rotor poles and wherein the stator includes a second plurality of stator poles; and wherein the instruction set executable to characterize operation of the switched reluctance motor comprises the instruction set executable to:
align one of the rotor poles with a corresponding one of the stator poles associated with a first electrical phase of the switched reluctance motor,
apply a first voltage pulse to the one of the electrical phases having the one of the rotor poles aligned with the one of the stator poles associated with the first of the electrical phases, and simultaneously monitor electrical current in the first of the electrical phases, and
determine a relationship between inductance at the aligned rotor pole and the monitored electrical current based thereon.

5. The starter of claim 4, wherein the relationship between inductance at the aligned one of the rotor poles and the monitored electrical current is expressed as follows:
L(θ,i)=L₀(i)+Σₓ₌₁ⁿ(Lₓ(i)*(cos(xNrθ+ϕx)))
wherein
L₀(i)=f(Lₐ(i),Lₘ(i),Lᵤ(i)), and
Lₓ(i)=g(Lₐ(i),Lₘ(i),Lᵤ(i))
and wherein:
L(θ, i) represents inductance at a given electrical angle θ and current i;
La(i) is an aligned inductance;
Lm(i) is a midpoint inductance;
Lu(i) is an unaligned inductance;
Nr is a quantity of the rotor poles of the switched reluctance motor; and
ϕx is a phase angle.

6. The starter of claim 4, further comprising the instruction set executable to:
apply a second voltage pulse to a second of the electrical phases having one of the rotor poles unaligned with the stator pole for the first of the electrical phases and simultaneously monitor electrical current in the second of the electrical phases, and
determine a relationship between inductance at the unaligned rotor pole and the monitored electrical current based thereon.

7. The starter of claim 6, further comprising the instruction set executable to:
apply a third voltage pulse to a third of the electrical phases having another one of the rotor poles unaligned with the stator pole for the first of the electrical phases and simultaneously monitor electrical current in the third of the electrical phases, and
determine a relationship between inductance at the unaligned rotor poles and the monitored electrical current based upon the electrical current in the second of the electrical phases and the electrical current in the third of the electrical phases.

8. A method for controlling a multi-phase switched reluctance motor including a rotor and a stator, an electronic commutator subassembly including an electronic motor control unit, a power inverter, and a rotational position sensor, wherein the power inverter is electrically connected to the stator of the switched reluctance motor, the method comprising:
characterizing operation of the switched reluctance motor,
dynamically determining inductance of the switched reluctance motor based upon the characterized operation, and
executing a closed-loop torque control routine to control the switched reluctance motor based upon the dynamically determined inductance of the switched reluctance motor;
wherein the torque output from the switched reluctance motor is dynamically determined based upon the dynamically determined inductance.

9. The method of claim 8, further comprising:
dynamically monitoring rotational position of the rotor and current and voltage supplied to the switched reluctance motor, and
dynamically determining the inductance of the switched reluctance motor based upon the characterized operation, the rotational position of the rotor, the current and the voltage supplied to the switched reluctance motor.

10. The method of claim 9, further comprising the instruction set being executable to:
dynamically determining a torque output from the switched reluctance motor based upon the inductance of the switched reluctance motor;
determining a torque command for the switched reluctance motor; and
controlling the switched reluctance motor based upon the dynamically determined torque output from the switched reluctance motor and the torque command.

11. A method for controlling a multi-phase switched reluctance motor including a rotor and a stator, an electronic commutator subassembly including an electronic motor control unit, a power inverter, and a rotational position sensor, wherein the power inverter is electrically connected to the stator of the switched reluctance motor and wherein the rotor includes a first plurality of rotor poles and wherein the stator includes a second plurality of stator poles, the method comprising:
characterizing operation of the switched reluctance motor;
dynamically determining inductance of the switched reluctance motor based upon the characterized operation;
dynamically determining a torque output from the switched reluctance motor based upon the dynamically determined inductance; and
controlling the switched reluctance motor based upon the dynamically determined inductance of the switched reluctance motor and the torque output from the switched reluctance motor.

12. The method of claim 11, further comprising:
dynamically monitoring rotational position of the rotor and current and voltage supplied to the switched reluctance motor, and
dynamically determining the inductance of the switched reluctance motor based upon the characterized operation, the rotational position of the rotor, the current and the voltage supplied to the switched reluctance motor.

13. The method of claim 11, wherein dynamically determining a torque output from the switched reluctance motor based upon the inductance of the switched reluctance motor comprises:
determining a torque command for the switched reluctance motor; and
controlling the switched reluctance motor based upon the dynamically determined torque output from the switched reluctance motor and the torque command.

14. The method of claim 11, wherein controlling the switched reluctance motor comprises executing a closed-loop torque control routine to control the switched reluctance motor based upon the dynamically determined inductance of the switched reluctance motor.

15. The method of claim 11, wherein characterizing operation of the switched reluctance motor comprises:
aligning one of the rotor poles with a corresponding one of the stator poles associated with a first electrical phase of the switched reluctance motor,
applying a first voltage pulse to the one of the electrical phases having the one of the rotor poles aligned with the one of the stator poles associated with the first of the electrical phases, and simultaneously monitor electrical current in the first of the electrical phases, and
determining a relationship between inductance at the aligned rotor pole and the monitored electrical current based thereon.

16. The method of claim 15, wherein the relationship between inductance at the aligned rotor pole and the monitored electrical current is expressed as follows:
L(θ,i)=L₀(i)+Σₓ₌₁ⁿ(Lₓ(i)*(cos(xNrθ+ϕx)))
wherein
L₀(i)=f(Lₐ(i),Lₘ(i),Lᵤ(i)), and
Lₓ(i)=g(Lₐ(i),Lₘ(i),Lᵤ(i))
and wherein:
L(θ, i) represents inductance at a given electrical angle θ and current i;
La(i) is an aligned inductance;
Lm(i) is a midpoint inductance;
Lu(i) is an unaligned inductance;
Nr is a quantity of the rotor poles of the switched reluctance motor; and
ϕx is a phase angle.

17. The method of claim 15, further comprising:
applying a second voltage pulse to a second of the electrical phases having a rotor pole unaligned with the stator pole for the first of the electrical phases and simultaneously monitor electrical current in the second of the electrical phases, and
determining the relationship between inductance at the unaligned rotor pole and the monitored electrical current based thereon.
